(19) United States
(12) Patent Application Publication
(10) Pub. No.: US 2022/0135165 A1
(43) Pub. Date: May 5, 2022

(54) DRIVE ASSISTANCE DEVICE FOR SADDLE RIDING-TYPE VEHICLE

(71) Applicant: HONDA MOTOR CO., LTD., Minato-ku, Tokyo (JP)

(72) Inventors: Tsutomu Tamashima, Wako-shi (JP); Tsubasa Nose, Wako-shi (JP); Kiyotaka Sakai, Wako-shi (JP); Hiroaki Uchisasai, Wako-shi (JP); Yuta Kanbe, Wako-shi (JP)

(21) Appl. No.: 17/437,430

(22) PCT Filed: Mar. 29, 2019
(86) PCT No.: PCT/JP2019/014097

§ 371 Date: Sep. 9, 2021

(51) Int. Cl. B62J 45/20; B60W 30/16; B60W 30/045; B60W 10/04; B60W 10/18; B62J 99/00

(52) U.S. Cl. CPC B62J 45/20; B60W 30/16; B60W 30/045; B60W 10/04; B60W 10/18; B60W 2710/18; B60W 2300/36; B60W 2720/10; B60W 2720/12; B60W 2754/30; B62J 99/00

(57) ABSTRACT

A drive assistance device for a saddle riding-type vehicle includes an outside detecting part that detects a situation around the vehicle, a brake device that brakes a host vehicle, a driving device that drives the host vehicle, and a controller that controls operation of the brake device and the driving device, and the controller performs following-travel-control that causes the host vehicle to travel with a first vehicular gap while following a preceding vehicle by actuating at least one of the brake device and the driving device, adjusts actuation of at least one of the brake device and the driving device when the outside detecting part detects a corner in a direction in which the host vehicle advances while the following-travel-control is performed, and performs control of setting a vehicular gap with respect to the preceding vehicle as a second vehicular gap that is greater than the first vehicular gap.

### TECHNICAL FIELD

The present invention relates to a drive assistance device for a saddle riding-type vehicle.

### BACKGROUND ART

For example, Patent Literature 1 discloses a control device for the purpose of providing highly responsive drive assistance without impairing a driving feeling of a saddle riding-type vehicle. The control device includes a prediction unit and a vehicle control unit. The prediction unit predicts occurrence of vehicle turning by determining a rider's intention of turning the vehicle on the basis of information of at least one of a pre-turning behavior of a predetermined vehicle body and a drive operation of the rider. The vehicle control unit performs drive assistance upon vehicle turning on the basis of the prediction result by the prediction unit.

### CITATION LIST

### Patent Literature

[Patent Literature 1]
PCT International Publication No. WO2018/216308

### SUMMARY OF INVENTION

### Technical Problem

Incidentally, in the related art, there is no disclosure about how to take a vehicular gap when there is another vehicle upon cornering. That is, since a saddle riding-type vehicle such as a motorcycle or the like performs turning by banking a vehicle body to an inner side of a corner, acceleration adjustment easily occurs more than in a passenger car. Accordingly, when the cornering is performed to follow a preceding vehicle, even when a vehicular gap is kept constant, the vehicular gap may vary unintentionally. For this reason, a configuration of controlling a vehicular gap actively upon cornering is desired.

Here, the present invention is directed to providing a drive assistance device for a saddle riding-type vehicle capable of appropriately controlling a vehicular gap when cornering is performed to follow a preceding vehicle.

### Solution to Problem

In order to achieve the aforementioned objects, a first aspect of the present invention is a drive assistance device for a saddle riding-type vehicle including: an outside detecting part (29) configured to detect a situation around the vehicle; a brake device (BR) configured to brake a host vehicle; a driving device (EN) configured to drive the host vehicle; and a controller (27) configured to control operation of the brake device (BR) and the driving device (EN), and the controller (27) performs following travel control that causes the host vehicle to travel with a first vehicular gap (K1) while following a preceding vehicle (1A) by actuating at least one of the brake device (BR) and the driving device (EN), adjusts actuation of at least one of the brake device (BR) and the driving device (EN) when the outside detecting part (29) detects a corner in a direction in which the host vehicle advances while the following travel control is performed, and performs control of setting a vehicular gap with respect to the preceding vehicle (1A) as a second vehicular gap (K2) that is greater than the first vehicular gap (K1).

According to this configuration, during the following travel control, the vehicular gap with respect to the preceding vehicle is increased as the outside detecting part detects a corner in front of the vehicle. Accordingly, it is possible to minimize occurrence of the acceleration and deceleration during cornering. The acceleration and deceleration during cornering of the saddle riding-type vehicle (upon vehicle body bank) require an effort in controlling a vehicle body behavior because not only the vehicle body behavior in a pitching direction but also the vehicle body behavior in a rolling direction occurs. Accordingly, it is possible to reduce tiredness of a rider by minimizing occurrence of the acceleration and deceleration during cornering.

According to a second aspect of the present invention, in the first aspect, the controller (27) performs control of maintaining the second vehicular gap (K2) during cornering in the following travel control.

According to this configuration, a state, in which the vehicular gap with respect to the preceding vehicle is increased, is maintained during cornering in the following travel control. Accordingly, it is possible to reduce the tiredness of the rider by giving a margin to the acceleration and deceleration during cornering.

According to a third aspect of the present invention, in the second aspect, in a case the outside detecting part (29) loses sight of a preceding vehicle during cornering in the following travel control, the controller (27) adjusts actuation of at least one of the brake device (BR) and the driving device (EN) and performs control of closing a vehicular gap until a preceding vehicle (1A) is detected.

According to this configuration, upon following travel control, when the preceding vehicle is lost by increasing the vehicular gap with respect to the preceding vehicle during cornering of a blind corner or the like with poor visibility, control of closing the vehicular gap is performed until the preceding vehicle is detected. Accordingly, stable drive assistance control can be performed without interrupting the following travel during cornering.

According to a fourth aspect of the present invention, in the second or third aspect, in a case the outside detecting part (29) detects a corner exit in the direction in which the host vehicle advances during cornering in the following travel control, the controller (27) adjusts actuation of at least one of the brake device (BR) and the driving device (EN) and performs control of returning a vehicular gap with respect to the preceding vehicle (1A) to the first vehicular gap (K1).

According to this configuration, upon following travel control, since the vehicular gap with respect to the preceding vehicle is returned to the first vehicular gap, which is a gap before the cornering, at the corner exit, it is possible to quickly return to a following travel state before the cornering after completion of the cornering.

According to a fifth aspect of the present invention, in any one of the first to fourth aspects, during the following travel control, the controller (27) has a control mode of shifting a traveling trajectory of the host vehicle in a lane width direction with respect to a preceding vehicle (1A) inside a lane along which the host vehicle is traveling, and performs control of adjusting a vehicular gap between the preceding vehicle (1A) and the host vehicle shifted in the lane width direction when cornering is performed in the control mode.

According to this configuration, for example, when group traveling is performed by a plurality of vehicles, it is possible to assist a so-called zigzag traveling, in which vehicles are shifted and arranged alternately in the lane width direction, and it is possible to perform the cornering while maintaining the zigzag traveling. For this reason, marketability of the drive assistance device can be enhanced.

### Advantageous Effects of Invention

According to the present invention, it is possible to provide a drive assistance device for a saddle riding-type vehicle capable of appropriately controlling a vehicular gap when cornering is performed to follow a preceding vehicle.

### BRIEF DESCRIPTION OF DRAWINGS

FIG. 1 is a configuration view of a vehicle system of an embodiment of the present invention.

FIG. 2 is a view for explaining an aspect in which a relative position and an attitude of a host vehicle with respect to a traveling lane are recognized by a recognition part of the vehicle system.

FIG. 3 is a view for explaining an aspect in which a target trajectory is generated on the basis of a recommended lane in the vehicle system.

FIG. 4 is a left side view of a motorcycle of an embodiment.

FIG. 5 is a configuration view of a control device of the motorcycle.

FIG. 6 is a configuration view of a drive assistance device of the motorcycle.

FIG. 7 is a view for explaining the motorcycle when seen from above.

FIG. 8 is a view for explaining a first example of drive assistance control of the motorcycle.

FIG. 9 is a view for explaining a second example of drive assistance control of the motorcycle.

FIG. 10 is a view for explaining a third example of drive assistance control of the motorcycle in a sequence of (a) and (b).

FIG. 11 is a view for explaining a fourth example of drive assistance control of the motorcycle.

FIG. 12 is a view for explaining a fifth example of drive assistance control of the motorcycle.

FIG. 13 is a view for explaining a sixth example of drive assistance control of the motorcycle, in which (a) shows a comparative example, and (b) shows the sixth example.

FIG. 14 is a view for explaining a seventh example of drive assistance control of the motorcycle.

### DESCRIPTION OF EMBODIMENTS

Hereinafter, an example of a vehicle system of an embodiment will be described with reference to the accompanying drawings.

In the embodiment, the vehicle system is applied to an automatic driving vehicle. Here, there are levels in automatic driving. The level in the automatic driving can be determined by a scale such as, for example, whether the level is less than a predetermined reference or whether the level is equal to or greater than the predetermined reference. The level in the automatic driving being less than the predetermined reference may be, for example, a case in which manual driving is performed or a case in which only a drive assistance device such as an adaptive cruise control system (ACC), a lane keeping assistance system (LKAS), or the like, is operated.

The driving mode in which the level in the automatic driving is less than the predetermined reference is an example of “a first driving mode.” In addition, the level in the automatic driving being equal to or greater than the predetermined reference may be, for example, a case in which a control level is higher than that in the ACC or the LKAS and a drive assistance device such as auto lane changing (ALC), low speed car passing (LSP), or the like, is actuated, or a case in which automatic driving automatically performed to lane change, merging, or diverging is executed. The driving mode in which the level in the automatic driving is equal to or greater than the predetermined reference is an example of “a second driving mode.” The predetermined reference can be arbitrarily set. In the embodiment, the first driving mode is manual driving, and the second driving mode is automatic driving.

<Entire System>

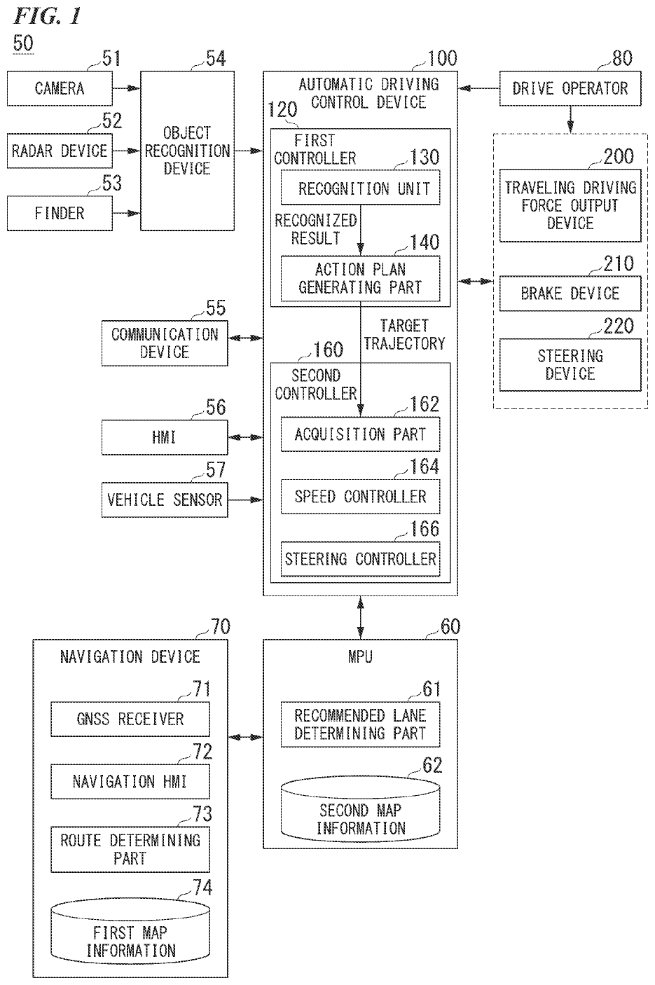

FIG. 1 is a configuration view of a vehicle system 50 according to an embodiment. A vehicle on which the vehicle system 50 is mounted is, for example, a two-wheeled, three-wheeled, or four-wheeled vehicle, and a driving source thereof is an internal combustion engine such as a gasoline engine, a diesel engine, or the like, an electric motor, or a combination of these. The electric motor is operated using an output generated by a generator connected to the internal combustion engine, or discharged energy of a secondary battery or a fuel cell.

The vehicle system 50 includes, for example, a camera 51, a radar device 52, a finder 53, an object recognition device 54, a communication device 55, a human machine interface (HMI) 56, a vehicle sensor 57, a navigation device 70, a map positioning unit (MPU) 60, a drive operator 80, an automatic driving control device 100, a traveling driving force output device 200, a brake device 210, and a steering device 220. These devices or instruments are connected to each other by a multiple communication line such as a controller area network (CAN) communication line or the like, a serial communication line, a wireless communication network, or the like. Further, the configuration shown in FIG. 1 is merely an example, a part of the configuration may be omitted, and another configuration may be added.

The camera 51 is, for example, a digital camera using a solid-state image sensing device such as a charge coupled device (CCD), a complementary metal oxide semiconductor (CMOS), or the like. The camera 51 is attached to an arbitrary place of a vehicle (hereinafter, a host vehicle M) on which the vehicle system 50 is mounted. When a side in front of the host vehicle M is imaged, the camera 51 is attached to an upper section of a front windshield, a rear surface of a rearview mirror, or the like. In the case of a saddle riding-type vehicle such as a two-wheeled vehicle or the like, the camera 51 is attached to steered system parts or exterior parts or the like on the side of a vehicle body that supports the steered system parts. The camera 51, for example, images surroundings of the host vehicle M periodically and repeatedly. The camera 51 may be a stereo camera.

The radar device 52 radiates radio waves such as millimeter waves or the like to surroundings of the host vehicle M and, simultaneously, detects the radio waves (reflected waves) reflected by the object to detect at least a position (a distance and an azimuth) of the object. The radar device 52 is attached to an arbitrary place of the host vehicle M. The radar device 52 may detect a position and a speed of the object using a frequency modulated continuous wave (FM-CW) method.

The finder 53 is light detection and ranging (LIDAR). The finder 53 radiates light to surroundings of the host vehicle M and measures scattered light. The finder 53 detects a distance to a target on the basis of a time from emission to reception of light. The radiated light is, for example, a pulse-shaped laser beam. The finder 53 is attached to an arbitrary place of the host vehicle M.

The object recognition device 54 recognizes a position, a type, a speed, or the like, of the object by performing sensor fusion processing with respect to the detection result by some or all of the camera 51, the radar device 52, and the finder 53. The object recognition device 54 outputs the recognized result to the automatic driving control device 100. The object recognition device 54 may output the detection results of the camera 51, the radar device 52, and the finder 53 to the automatic driving control device 100 without change. The object recognition device 54 may be omitted from the vehicle system 50.

The communication device 55 uses, for example, a cellular network, a Wi-Fi network, a Bluetooth (registered trademark), dedicated short range communication (DSRC), or the like, comes in communication with another vehicle present in the vicinity of the host vehicle M, or comes in communication with various server devices via a radio base station.

The HMI 56 receives an input operation by an occupant in the host vehicle M while providing various types of information to the occupant. The HMI 56 includes various display devices, a speaker, a buzzer, a touch panel, a switch, a key, or the like.

The vehicle sensor 57 includes a vehicle speed sensor configured to detect a speed of the host vehicle M, an acceleration sensor configured to detect an acceleration, a yaw rate sensor configured to detect an angular speed around a vertical axis, and an azimuth sensor configured to detect an orientation of the host vehicle M.

The navigation device 70 includes, for example, a global navigation satellite system (GNSS) receiver 71, a navigation HMI 72, and a route determining part 73. The navigation device 70 holds first map information 74 in a storage device such as a hard disk drive (HDD), a flash memory, or the like. The GNSS receiver 71 specifies a position of the host vehicle M on the basis of the signal received from a GNSS satellite. The position of the host vehicle M may be specified or complemented by an inertial navigation system (INS) using the output of the vehicle sensor 57. The navigation HMI 72 includes a display device, a speaker, a touch panel, a key, and the like. The navigation HMI 72 may be shared with a part or the entirety of the HMI 56 described above. The route determining part 73 determines, for example, a route to a destination input by an occupant using the navigation HMI 72 (hereinafter, a route on a map) from a position of the host vehicle M specified by the GNSS receiver 71 (or an input arbitrary position) with reference to the first map information 74. The first map information 74 is, for example, information in which a road shape is expressed by a link showing a road and a node connected by the link. The first map information 74 may include a curvature of a road, point of interest (POI) information, or the like. The route on a map is output to the MPU 60. The navigation device 70 may perform route guidance using the navigation HMI 72 on the basis of the route on a map. The navigation device 70 may be realized by, for example, a function of a terminal device such as a smart phone, a tablet terminal, or the like, held by the occupant. The navigation device 70 may transmit the current position and the destination to the navigation server via the communication device 55 and acquire the same route as the route on a map from the navigation server.

The MPU 60 includes, for example, a recommended lane determining part 61 and holds second map information 62 in a storage device such as an HDD, a flash memory, or the like. The recommended lane determining part 61 divides the route on a map provided from the navigation device 70 into a plurality of blocks (for example, divided at each 100 [m] in a direction in which the vehicle advances) and determines a recommended lane at each block with reference to the second map information 62. The recommended lane determining part 61 performs determination that the vehicle travels in which number of a lane from the left. The recommended lane determining part 61 determines a recommended lane so that the host vehicle M can travel a reasonable route to go to a branch destination when a diverging place is present on the route on a map.

The second map information 62 is map information that is more precise than the first map information 74. The second map information 62 includes, for example, information of a center of a lane, information of a boundary of a lane, or the like. In addition, the second map information 62 may include road information, traffic regulation information, address information (address/zip code), facility information, telephone number information, and the like. The second map information 62 may be updated at any time by bring the communication device 55 in communication with another device.

The drive operator 80 includes, for example, an accelerator pedal (and a grip), a brake pedal (and a lever), a shift lever (and a pedal), a steering wheel (and a bar handle), heteromorphic steering, a joystick, and other operators. A sensor configured to detect an operation amount or existence of an operation is attached to the drive operator 80, and the detection result is output to some or all of the automatic driving control device 100, the traveling driving force output device 200, the brake device 210, and the steering device 220.

The automatic driving control device 100 includes, for example, a first controller 120 and a second controller 160. The first controller 120 and the second controller 160 are realized by executing a program (software) using a hardware processor such as a central processing unit (CPU) or the like. In addition, some or all of these components may be realized by hardware (a circuit part; including a circuitry) such as large scale integration (LSI), an application specific integrated circuit (ASIC), a field-programmable gate array (FPGA), a graphics processing unit (GPU), or the like or may be realized by cooperation of software and hardware.

The first controller 120 includes, for example, a recognition part 130 and an action plan generating part 140. The first controller 120 realizes, for example, both of a function of artificial intelligence (AI) and a function of a previously provided model at the same time. For example, a function of “recognizing a crossroad” is executed parallel to recognition of a crossroad through deep learning or the like and recognition based on a previously provided condition (a signal that enables matching of patterns, road markings, or the like) and may be realized by scoring and comprehensively evaluating them. Accordingly, reliability of automatic driving is secured.

The recognition part 130 recognizes a state such as a position, a speed, an acceleration, and the like, of an object (another vehicle or the like) around the host vehicle M on the basis of information input from the camera 51, the radar device 52, and the finder 53 via the object recognition device 54. The position of the object may be recognized as, for example, a position on absolute coordinates using a representative point (a center of gravity, a driving shaft center, or the like) of the host vehicle M as an origin and used for control. The position of the object may be expressed at a representative point such as a center of gravity, a corner, or the like, of the object or may be represented as an expressed region. “A state” of the object may include an acceleration or a jerk of the object, or “an action state” (for example, whether a lane change is performed or to be performed).

In addition, the recognition part 130 recognizes, for example, a lane (a traveling lane) along which the host vehicle M travels. For example, the recognition part 130 recognizes a traveling lane by comparing a pattern (for example, arrangement of solid line and broken lines) of road marking lines obtained from the second map information 62, and a pattern of road marking lines around the host vehicle M recognized from the image captured by the camera 51. Further, the recognition part 130 may recognize the traveling lane by recognizing traveling lane boundaries (road boundaries) including road marking lines, road shoulders, curbstones, median strips, guardrails, and the like while not being limited to road marking lines. In the recognition, the position of the host vehicle M acquired from the navigation device 70 or a processing result by the INS may be added. In addition, the recognition part 130 may recognize a temporary stop line, an obstacle, a red signal, a tollgate, and other road events.

The recognition part 130 recognizes a position or an attitude of the host vehicle M with respect to the traveling lane when the traveling lane is recognized.

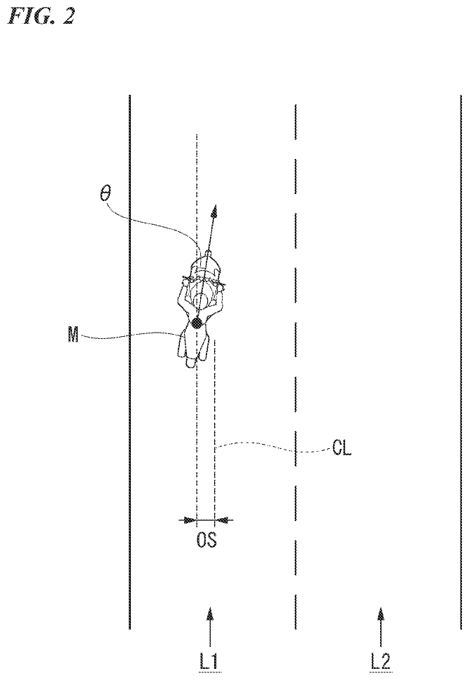

FIG. 2 is a view showing an example of an aspect in which a relative position and an attitude of the host vehicle M with respect to a traveling lane L1 are recognized by the recognition part 130. The recognition part 130 may recognize, for example, a separation OS from a traveling lane center CL of a reference point (for example, a center of gravity) of the host vehicle M and an angle θ with respect to a line connecting the traveling lane centers CL in a direction in which the host vehicle M advances as a relative position and an attitude of the host vehicle M with respect to the traveling lane L1. In addition, instead of this, the recognition part 130 may recognize a position or the like of reference points of the host vehicle M with respect to a side end portion from any position of the traveling lane L1 (road marking lines or road boundaries) as a relative position of the host vehicle M with respect to the traveling lane.

Returning to FIG. 1, the action plan generating part 140 generates a target trajectory along which the host vehicle M automatically (regardless of a driver's operation) travels in the future so that the host vehicle travels a recommended lane determined by the recommended lane determining part 61 in principle and, further, so that the host vehicle can correspond to a surrounding situation of the host vehicle M. The target trajectory includes, for example, a speed element. For example, the target trajectory is expressed as the order of the points (trajectory points) to be reached by the host vehicle M. The trajectory point is a point at which the host vehicle M should arrive after each of predetermined traveling distances (for example, about several [m]) by a road distance, and separately from this, the target speed and the target acceleration are generated as a part of the target trajectory for every predetermined sampling time (for example, about every several fractions of a [sec]). In addition, the trajectory point may be a position at which the host vehicle M should arrive in the sampling time for every predetermined sampling time. In this case, information of the target speed or the target acceleration is expressed as intervals between the trajectory points.

The action plan generating part 140 may set the automatic driving event when the target trajectory is generated. The automatic driving event includes, for example, a fixed speed traveling event in which the host vehicle M travels along the same traveling lane at a fixed speed, a following traveling event in which the host vehicle M travels to follow a preceding vehicle, a lane change event in which a traveling lane of the host vehicle M is changed, a diverging event in which the host vehicle M travels in a target direction at a diverging point of a road, a merging event in which the host vehicle M merges at a merging point, an overtaking event in which the host vehicle M overtakes a preceding vehicle, and the like. The action plan generating part 140 generates a target trajectory according to the started event.

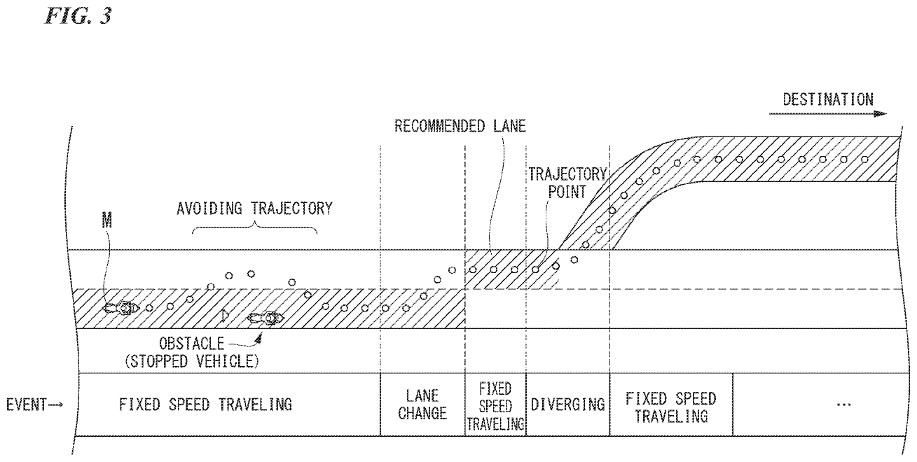

FIG. 3 is a view showing an aspect in which the target trajectory is generated on the basis of the recommended lane. As shown, the recommended lane is set to be convenient for traveling along the route to the destination. The action plan generating part 140 starts a lane change event, a diverging event, a merging event, or the like, when the host vehicle M approaches a predetermined distance before a switching point of the recommended lane (may be determined according to the type of event). In execution of each event, when there is necessity of avoiding an obstacle, an avoiding trajectory as shown is generated.

Returning to FIG. 1, the second controller 160 controls the traveling driving force output device 200, the brake device 210, and the steering device 220 such that the host vehicle M passes through the target trajectory generated by the action plan generating part 140 at a scheduled time.

The second controller 160 includes, for example, an acquisition part 162, a speed controller 164, and a steering controller 166. The acquisition part 162 acquires information of the target trajectory (trajectory points) generated by the action plan generating part 140, and stores the acquired information in a memory (not shown). The speed controller 164 controls the traveling driving force output device 200 or the brake device 210 on the basis of the speed element associated with the target trajectory stored in the memory. The steering controller 166 controls the steering device 220 according to a curve condition of the target trajectory stored in the memory. The processing of the speed controller 164 and the steering controller 166 are realized by, for example, combination of feedforward control and feedback control. As an example, the steering controller 166 combines the feedforward control according to the curvature of the road in front of the host vehicle M and the feedback control based on the separation from the target trajectory and executes the combination.

The traveling driving force output device 200 outputs a traveling driving force (torque) to a driving wheel such that the host vehicle M travels. The traveling driving force output device 200 includes, for example, combination of an internal combustion engine, an electric motor, a gearbox, and the like, and an electronic control unit (ECU) configured to control them. The ECU controls the above-mentioned configuration according to the information input from the second controller 160 or the information input from the drive operator 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the second controller 160 or the information input from the drive operator 80 such that the brake torque according to the braking operation is output to each wheel. The brake device 210 may include a mechanism configured to transmit a hydraulic pressure generated by an operation of the brake pedal included in the drive operator 80 to the cylinder via the master cylinder as a backup. Further, the brake device 210 is not limited to the above-mentioned configuration and may be an electronically controlled hydraulic brake device configured to control an actuator according to the information input from the second controller 160 and transmit a hydraulic pressure of the master cylinder to the cylinder.

The steering device 220 includes, for example, a steering ECU and an electric motor. The electric motor changes an orientation of a steered wheel by, for example, applying a force to a rack and pinion mechanism. The steering ECU drives the electric motor and changes an orientation of the steered wheel according to the information input from the second controller 160 or the information input from the drive operator 80.

### <Entire Vehicle>

Next, a motorcycle that is an example of a saddle riding-type vehicle according to the embodiment will be described. Further, directions of forward, rearward, leftward, rightward, and so on, in the following description are the same as directions in a vehicle described below unless the context clearly indicates otherwise. In addition, in appropriate places in the drawings used in the following description, an arrow FR indicates a forward direction with respect to a vehicle, and an arrow UP indicates an upward direction with respect to the vehicle.

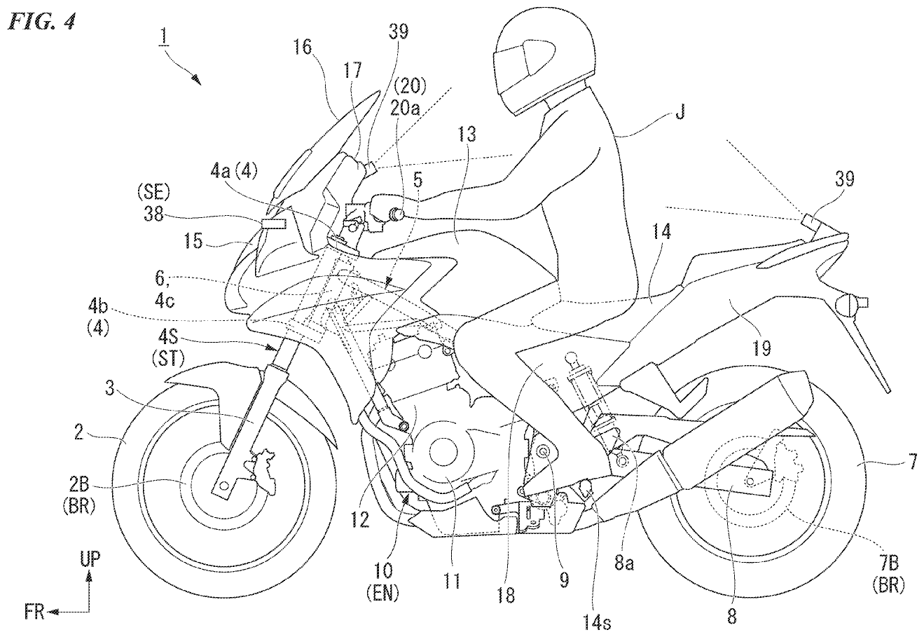

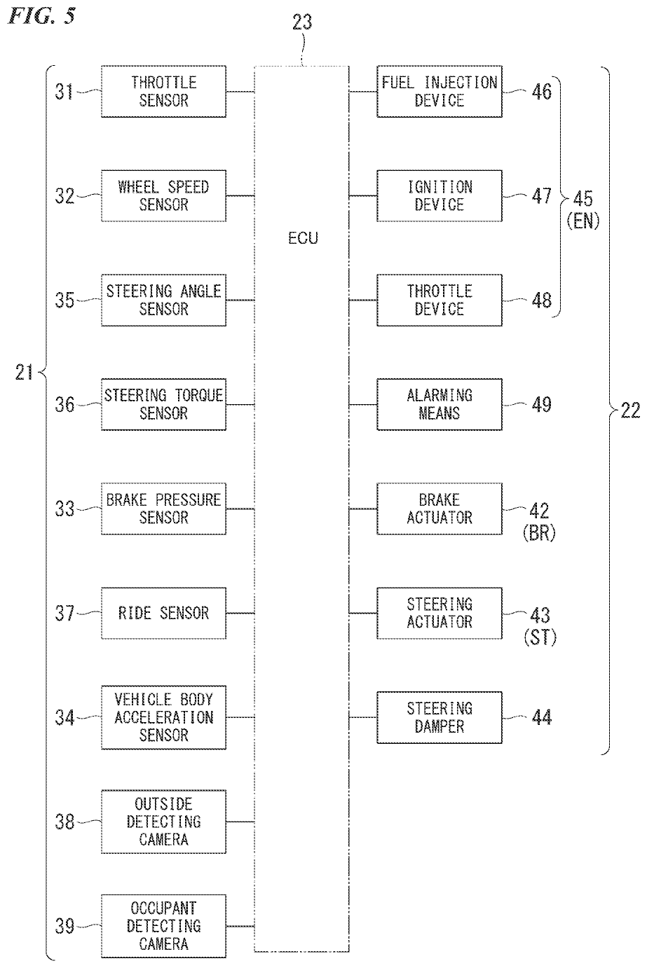

As shown in FIG. 4, a front wheel 2 that is a steering wheel of a motorcycle 1 is supported by lower end portions of a pair of left and right front forks 3. Upper sections of the left and right front forks 3 are steerably supported by a head pipe 6 of a front end portion of a vehicle body frame 5 via a steering stem 4. The steering stem 4 includes a steering shaft 4c inserted through and pivotably supported by the head pipe 6, and upper and lower bridge members (a top bridge 4a and a bottom bridge 4b) fixed to upper and lower end portions of the steering shaft 4c, respectively. A bar type handle 20 is attached to at least one of the upper section (the top bridge 4a) of the steering stem 4 and the left and right front forks 3. The handle 20 includes a pair of left and right grips 20a gripped by a rider (a driver) J. In the drawings, reference sign 4S indicates a steering mechanism including the steering stem 4 and the left and right front forks 3, and reference sign ST indicates a steering device including the steering mechanism 4S and a steering actuator 43 (see FIG. 5).

A rear wheel 7 that is a driving wheel of the motorcycle 1 is supported by a rear end portion of a swing arm 8 extending below a rear section of a vehicle body in a forward/rearward direction. A front end portion of the swing arm 8 is vertically swingably supported by a pivot section 9 of a longitudinal intermediate section of the vehicle body frame 5. A rear cushion 8a is disposed between the front section of the swing arm 8 and the longitudinal intermediate section of the vehicle body frame 5.

An engine (an internal combustion engine) 10 that is a prime mover is supported by the vehicle body frame 5. The engine 10 has a cylinder 12 standing above a front section of a crank case 11. A fuel tank 13 in which fuel for the engine 10 is stored is disposed above the engine 10. A seat 14 on which an occupant (a driver and a passenger on a rear part) sits is disposed behind the fuel tank 13. A pair of left and right steps 14s on which the rider J can put his/her legs are disposed at both of left and right sides under the seat 14. A front cowl 15 supported by the vehicle body frame 5 is mounted on a front section of the vehicle body. A screen 16 is provided on a front upper side of the front cowl 15. A meter device 17 is disposed on an inner side of the front cowl 15. A side cover 18 is mounted on a side portion of the vehicle body below the seat 14. A rear cowl 19 is mounted on a rear section of the vehicle body.

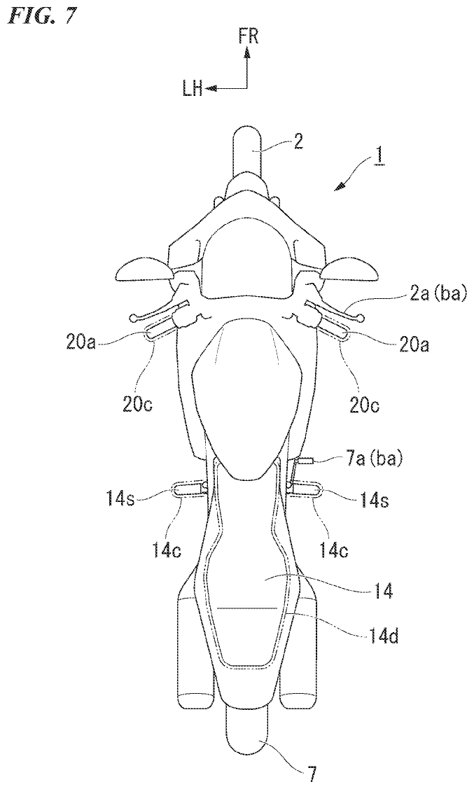

The motorcycle 1 includes a front wheel brake main body 2B, a rear wheel brake main body 7B, and a brake actuator 42 (see FIG. 5). Each of the front wheel brake main body 2B and the rear wheel brake main body 7B is a hydraulic disc brake. The motorcycle 1 constitutes a by-wire type brake system configured to electrically link the front wheel brake main body 2B and the rear wheel brake main body 7B to a brake operator ba such as a brake lever 2a, a brake pedal 7a (see FIG. 7), and the like, operated by the rider J. In the drawings, reference sign BR indicates a brake device including the front and rear brake main bodies 2B and 7B and the brake actuator 42.

Here, the brake device BR constitutes an interlocking front/rear brake system (a combined brake system (CBS)) configured to generate braking forces of front and rear wheels by linking the front and rear brake main bodies 2B and 7B upon operation of one of the brake lever 2a and the brake pedal 7a. In addition, the brake device BR constitutes an antilock brake system (ABS) configured to appropriately control slip ratios of front and rear wheels by depressurizing a brake pressure according to slip states of the front and rear wheels upon operations of the front and rear brake main bodies 2B and 7B.

FIG. 5 is a configuration view of a major part of the motorcycle 1 according to the embodiment.

The motorcycle 1 includes a control device 23 configured to control operations of various devices 22 based on detection information acquired from various sensors 21. The control device 23 is configured as, for example, an integrated or a plurality of electronic control devices (ECUs). The control device 23 may be at least partially realized by cooperation of software and hardware. The control device 23 includes a fuel injection controller, an ignition controller and a throttle controller, which are configured to control driving of the engine 10. The motorcycle 1 constitutes a by-wire type engine control system configured to electrically link auxiliary machinery such as a throttle device 48 or the like, and an accelerator operator such as an accelerator grip or the like operated by the rider J.

The various sensors 21 include a vehicle body acceleration sensor 34, a steering angle sensor 35, a steering torque sensor 36, a ride sensor 37, an outside detecting camera 38 and an occupant detecting camera 39, in addition to a throttle sensor 31, a wheel speed sensor 32 and a brake pressure sensor 33.

The various sensors 21 detect various operation inputs of the rider J and various states of the motorcycle 1 and the occupant. The various sensors 21 output various types of detection information to the control device 23.

The throttle sensor 31 detects an operation amount (an acceleration request) of an accelerator operator such as a throttle grip or the like.

The wheel speed sensors 32 are provided on the front and rear wheels 2 and 7, respectively. Detection information of the wheel speed sensors 32 are used for control of the ABS, traction control, and the like. The detection information of the wheel speed sensors 32 may be used as vehicle speed information transmitted to the meter device 17.

The brake pressure sensor 33 detects an operation force (a deceleration request) of the brake operator ba such as the brake lever 2a, the brake pedal 7a, and the like.

The vehicle body acceleration sensor 34 is an inertial measurement device (IMU) having five axes or six axes, and detects angles (or an angular speed) of three axes ((a roll axis, a pitch axis and a yaw axis) and an acceleration in the vehicle body. Hereinafter, the vehicle body acceleration sensor 34 may be referred to as an IMU 34.

The steering angle sensor 35 is, for example, a potentiometer provided on the steering shaft 4c, and detects a pivot angle (a steering angle) of the steering shaft 4c with respect to the vehicle body.

Referring also to FIG. 4, the steering torque sensor 36 is, for example, a magneto-striction type torque sensor provided between the handle 20 and the steering shaft 4c, and detects a torsion torque (steering input) input from the handle 20 to the steering shaft 4c. The steering torque sensor 36 is an example of a load sensor configured to detect a steering force input to the handle 20 (the steering operator).

In the embodiment, the handle pivot shaft that pivotably supports the handle 20 is the same as the steering shaft 4c that steerably supports the front wheel 2.

Here, the steering mechanism 4S of the embodiment is a general term for a configuration in which the steering mechanism 4S is provided between the handle 20 and the front wheel 2 (the steering wheel) and pivotal movement of the handle 20 is transmitted to the front wheel 2. The handle pivot shaft and the steering shaft (the front wheel pivot shaft) are configured to be the same as each other, and may be provided separately from each other or on different shafts. When the handle pivot shaft and the steering shaft are provided on the different shafts, a configuration of linking the handle pivot shaft and the steering shaft is included in the steering mechanism 4S.

The ride sensor 37 detects whether the rider J is in a regular ride attitude. The ride sensor 37 may be exemplified as, for example, a seat sensor 14d disposed on the seat 14 and configured to detect whether the rider J sits on the seat, left and right grip sensors 20c disposed on left and right grips 20a of the handle 20 and configured to detect whether the rider J grips the left and right grips 20a, left and right step sensors 14c disposed on left and right steps 14s and configured to detect whether the rider J puts his/her legs thereon, and the like.

Referring also to FIG. 7, the grip sensors 20c include a load sensor such as a piezoelectric sensor or the like configured to detect a degree and an orientation of a load due to gripping of the rider J, and an acceleration sensor configured to measure an oscillation frequency of the grips 20a. Information detected by the grip sensors 20c is input to the control device 23.

The step sensors 14c also include a load sensor configured to detect a degree and an orientation of a load due to the legs thereon of the rider J, and an acceleration sensor configured to measure an oscillation frequency of the steps 14s. Information detected by the step sensors 14c is input to the control device 23.

The seat sensor 14d includes a load sensor such as a piezoelectric sensor or the like configured to detect a degree and an orientation of a load due to sitting of the rider J. Information detected by the seat sensor 14d is input to the control device 23.

The control device 23 detects that the rider J is in a driving state corresponding to one-hand driving based on a crosswise difference in degree of the gripping load detected by the grip sensors 20c. “The driving state corresponding to the one-hand driving” is a ride attitude state that is not regular, and a state in which the attitude of the rider J is easy to turbulence due to a behavior of the vehicle body. The control device 23 determines that the rider J is in the ride attitude that is not regular when the crosswise difference in degree of the gripping load is equal to or greater than a predetermined threshold. Here, when automatic control that causes the vehicle body behavior such as an automatic brake, automatic steering, or the like, is performed, the attitude of the rider J tends to be turbulence and lead to tiredness. When the control device 23 determines that the rider J is in the ride attitude that is not regular, it takes measures such as lowering the output of the automatic brake or automatic steering. Accordingly, the turbulence of the attitude of the rider J is suppressed.

In addition, the control device 23 detects that the rider J is in the driving state corresponding to the one-hand driving using also the crosswise difference in grip oscillation detected by the grip sensors 20c. That is, since a difference occurs in a relation between the engine rotation number and the grip oscillation frequency due to presence of gripping of the grips 20a, one-hand driving can be detected based on the crosswise difference in grip oscillation.

It is possible to accurately detect that the rider J is in the driving state corresponding to the one-hand driving using the grip load and the oscillation frequency.

Here, even when the rider J grips the left and right grips 20a, for example, in a state in which the rider J is looking back and stretching his/her limbs, like the one-hand driving, it can be said that the rider J is not in the regular driving attitude. The control device 23 detects not only the degree of the gripping load detected by the grip sensors 20c, but also an orientation of the gripping load. That is, the control device 23 determines that the rider J is in the driving attitude that is not regular also when the orientation of the gripping load is changed due to the rider J twisting the body, when the orientation of the gripping load is changed due to stretching of the rider. Even in this case, the control device 23 suppresses the turbulence of the attitude of the rider J by taking measures such as lowering the output of the automatic control. While the orientation of the gripping load may be set using the orientation downward in the vertical direction as the orientation of the reference, it may also be set by learning the orientation of the gripping load upon normal traveling without performing the automatic control.

When it is detected that the rider J is in an irregular driving attitude, alarming with respect to the rider J may be performed by actuating an alarming part 49, which will be described below, or the like. In addition, when it is detected that the rider J is in the irregular driving attitude, operations related to the acceleration of the motorcycle 1 (an operation that interferes with deceleration) such as a throttle opening operation or a shift-up operation may be disabled or invalidated. In this case, like the alarming to the rider J, notifications may be made to visual, auditory and tactile sensations of the rider J.

Returning to FIGS. 4 and 5, the outside detecting camera 38 images a situation in front of the vehicle. The outside detecting camera 38 is provided on, for example, a front end portion of the vehicle body (for example, a front end portion of the front cowl 15). The image captured by the outside detecting camera 38 is transmitted to, for example, the control device 23, subjected to appropriate image processing, and becomes desired image data to be used for various controls. That is, the information from the outside detecting camera 38 is provided for recognition of the position, type, speed, or the like, of the object in the detecting direction, and driving assist control, automatic driving control, or the like, of the vehicle is performed based on the recognition.

For example, the outside detecting camera 38 may be a camera that captures not only visible light but also invisible light such as infrared light or the like. As an outside detecting sensor instead of the outside detecting camera 38, not only an optical sensor such as a camera or the like but also a radio wave sensor such as radar or the like using microwaves such as infrared light, millimeter wave, or the like, may be used. Instead of a single sensor, a configuration including a plurality of sensors such as a stereo camera or the like may be used. A camera and radar may be used together.

The occupant detecting camera 39 is a digital camera that uses a solid state image sensing device such as a CCD, a CMOS, or the like, for example, like the outside detecting camera 38. The occupant detecting camera 39 is provided on, for example, an inner side of the front cowl 15 or an upper section of the rear cowl 19. The occupant detecting camera 39 captures the head and the upper half body of the rider J, for example, periodically and repeatedly. The image captured by the occupant detecting camera 39 is transmitted to, for example, the control device 23, and used for driving assist control, automatic driving control, or the like, of the vehicle.

The motorcycle 1 includes the steering actuator 43, a steering damper 44 and the alarming part 49, in addition to an engine controller 45 and the brake actuator 42. The engine controller 45 includes a fuel injection device 46, an ignition device 47, the throttle device 48, and the like. That is, the engine controller 45 includes auxiliary machinery configured to drive the engine 10. In the drawings, reference sign EN indicates a driving device including the engine 10 and auxiliary machinery.

The brake actuator 42 supplies a hydraulic pressure to the front wheel brake main body 2B and the rear wheel brake main body 7B and actuates them according to an operation to the brake operator ba. The brake actuator 42 functions as a control unit of the CBS and the ABS.

The steering actuator 43 outputs a steering torque to the steering shaft 4c. The steering actuator 43 actuates an electric motor according to the detection information of the steering torque sensor 36 and applies an assist torque to the steering shaft 4c.

The steering damper 44 is disposed in the vicinity of, for example, the head pipe 6, and applies a damping force to a steering system including the handle 20 in a steering direction (a rotation direction around the steering shaft 4c). The steering damper 44 is, for example, an electronically controlled damper with a variable damping force, and actuation thereof is controlled by the control device 23. For example, the steering damper 44 decreases a damping force applied to the steering system upon stopping or at a low vehicle speed of the motorcycle 1, and increases a damping force applied to the steering system at a middle/high vehicle speed of the motorcycle 1. The steering damper 44 may be any one of a vane type and a rod type as long as the damping force is variable depending on the control of the control device 23.

The alarming part 49 performs alarming to the rider J, for example, when it is determined that the rider J is not the prescribed ride attitude. The alarming part 49 gives the rider J a visual, auditory or tactile warning. For example, the alarming part 49 is exemplified as an indicator lamp, a display device, a speaker, an oscillator, and the like. The indicator lamp and the display device are disposed on, for example, the meter device 17. The speaker is installed in, for example, a helmet, and connected to a sound signal output part provided on the control device 23 in a wireless or wired manner. The oscillator is disposed at an area with which the body of the rider J in the prescribed ride attitude is in contact, for example, the seat 14, a knee grip (the fuel tank 13, the side cover 18, or the like), the grips 20a, the steps 14s, and the like.

### <Drive Assistance Device>

Next, an example of a drive assistance device of the motorcycle 1 of the embodiment will be described.

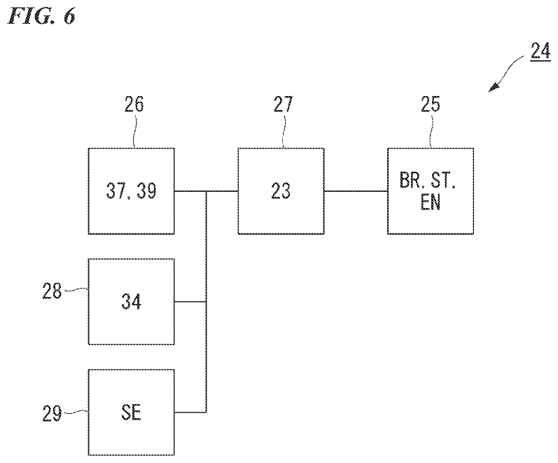

As shown in FIG. 6, a drive assistance device 24 of the embodiment includes: a vehicle body behavior generating part 25 configured to generate a behavior in a vehicle body by a prescribed output;

a ride attitude detecting part 26 configured to detect a ride attitude of the rider J;

a vehicle body behavior detecting part 28 configured to detect a roll angle from an erected state of the vehicle body;

an outside detecting part 29 configured to detect a situation around the vehicle; and

a controller 27 configured to control driving of the vehicle body behavior generating part 25 based on detection information of the ride attitude detecting part 26, the vehicle body behavior detecting part 28 and the outside detecting part 29.

The vehicle body behavior generating part 25 includes, for example, the brake device BR, the steering device ST and the driving device EN.

The brake device BR includes the front and rear brake main bodies 2B and 7B and the brake actuator 42. The brake device BR is actuated by at least one of the operation of the brake operator ba and the control of the controller 27 to generate a prescribed braking force.

The steering device ST includes the steering mechanism 4S and the steering actuator 43. The steering device ST is actuated by at least one of the operation of the steering operator and the control of the controller 27 to generate a prescribed steering force.

The driving device EN includes engine auxiliary machinery such as the throttle device 48 or the like. The engine auxiliary machinery is actuated by at least one of the operation of the accelerator operator and the control of the controller 27 to generate a prescribed driving force of the engine 10.

The ride attitude detecting part 26 includes, for example, the ride sensor 37 and the occupant detecting camera 39.

The ride sensor 37 includes the grip sensors 20c, the step sensors 14c and the seat sensor 14d.

The occupant detecting camera 39 detects, for example, movements (moving amounts) of the head and the upper half body of the rider J. The occupant detecting camera 39 may detect movement of the body of the passenger on a rear part in addition to the movement of the body of the rider J.

The vehicle body behavior detecting part 28 includes, for example, the vehicle body acceleration sensor (IMU) 34. In particular, the IMU 34 detects angles (or angular speeds) and accelerations of the roll axis, the pitch axis and the yaw axis of the vehicle body including the roll angle from the erected state of the vehicle body.

The controller 27 is, for example, the control device 23. At least a part of the controller 27 may be realized by cooperation of software and hardware.

The outside detecting part 29 includes, for example, an outside detecting sensor SE constituted by various electromagnetic wave sensors. The outside detecting sensor SE includes the outside detecting camera 38 configured to capture a side in front of the vehicle, and simultaneously, includes a sensor or a camera configured to detect an object such as a vehicle or the like in front of and behind the vehicle. The outside detecting part 29 may include map information of a navigation system, in addition to the outside detecting sensor SE.

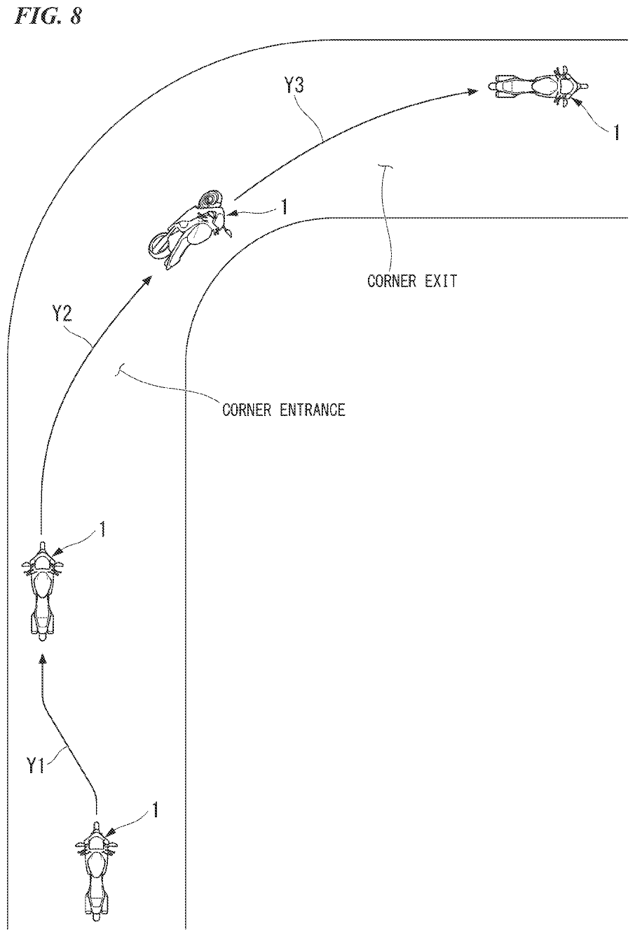

FIG. 8 is a view for explaining an example of drive assistance control.

The drive assistance control shown in FIG. 8 is control when cornering is performed in the case in which only a drive assistance device such as an adaptive cruise control system (ACC), a lane keeping assistance system (LKAS), or the like, is actuated. The control device 23 recognizes a curve of the traveling lane and supports cornering based on, for example, information in front of the vehicle captured by the outside detecting camera 38.

The control device 23 controls each part of the vehicle such that the host vehicle travels along a center in the lane width direction in the drive assistance upon normal traveling (upon corresponding to straight traveling in which a curvature of the lane is less than a predetermined threshold).

The control device 23 actuates, for example, the steering device ST and controls the traveling trajectory of the host vehicle within a range in which an operation of the rider J is not interfered when a corner in the direction in which the host vehicle advances is detected by the outside detecting part 29. Here, the control device 23 changes the traveling trajectory to an outside of the corner (an outer side) in the lane width direction in the lane during traveling of the host vehicle before arrival at the corner entrance (in the drawings, see an arrow Y1). The visibility of the corner is facilitated and the driving tiredness is reduced by changing the traveling trajectory to the outer side when the motorcycle 1 enters the corner. In addition, cornering with a change using the lane width is produced.

The control device 23 actuates, for example, the steering device ST and returns the traveling trajectory toward the lane center (a center side) within a range in which the operation of the rider J is not interfered when entering of the host vehicle to the corner is detected by the outside detecting part 29 (and the vehicle body behavior detecting part 28) (in the drawings, see an arrow Y2). A marginal cornering with an interval from the road section outside the corner is realized by changing the traveling trajectory from the outer side to the center side during cornering of the motorcycle 1. In addition, cornering with a change using a lane width is further produced.

The control device 23 actuates, for example, at least one of the steering device ST and the driving device EN and changes the traveling trajectory to the outside of the corner (the outer side) in the current traveling lane within a range in which the operation of the rider J is not interfered when a corner exit in the direction in which the host vehicle advances is detected by the outside detecting part 29 (in the drawings, see an arrow Y3). The acceleration at the corner exit becomes easier by changing the traveling trajectory to the outer side at the corner exit of the motorcycle 1. In addition, cornering (out-in-out) with a change using a lane width is further produced.

The control device 23 is not limited to upon cornering, and can change the traveling trajectory within the width of the current traveling lane according to the situation around the vehicle detected by the outside detecting part 29.

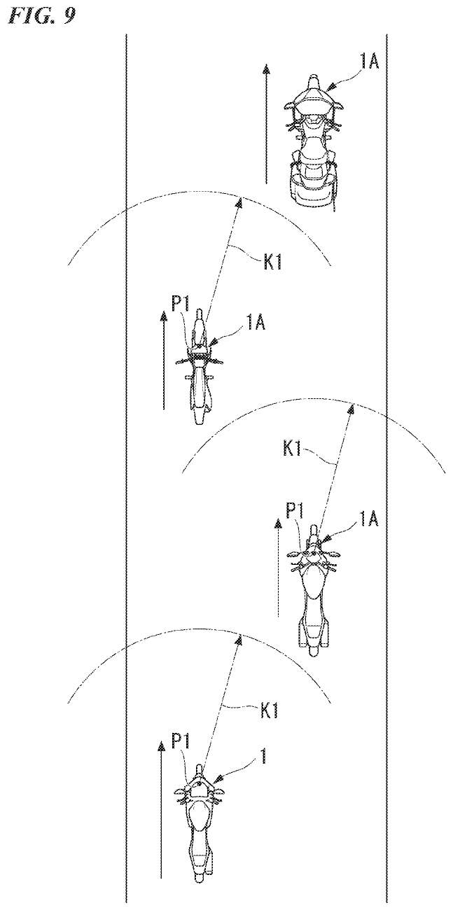

The drive assistance control shown in FIG. 9 shows an example of a control mode upon group traveling including the host vehicle. In the control mode, a plurality of motorcycles 1 arranged back and forth are arranged while being deviated alternately in the lane width direction (in other words, a so-called zigzag state). The control device 23 has a control mode in which the plurality of vehicles are arranged in a zigzag manner as described above in the drive assistance control, and can appropriately select the control mode according to the switching operation or the like of the rider J. The control device 23 measures, for example, a distance from a reference position P1 of a lens center or the like of the outside detecting sensor SE to a detecting object (a preceding vehicle 1A). When traveling in which the plurality of vehicles are arranged in a zigzag manner as described above (zigzag traveling) is performed, the control device 23 constantly holds a vehicular gap between the host vehicle M and the preceding vehicle 1A in a direction in which the preceding vehicle 1A disposed at a front side inclined with respect to the vehicle forward/rearward direction is oriented.

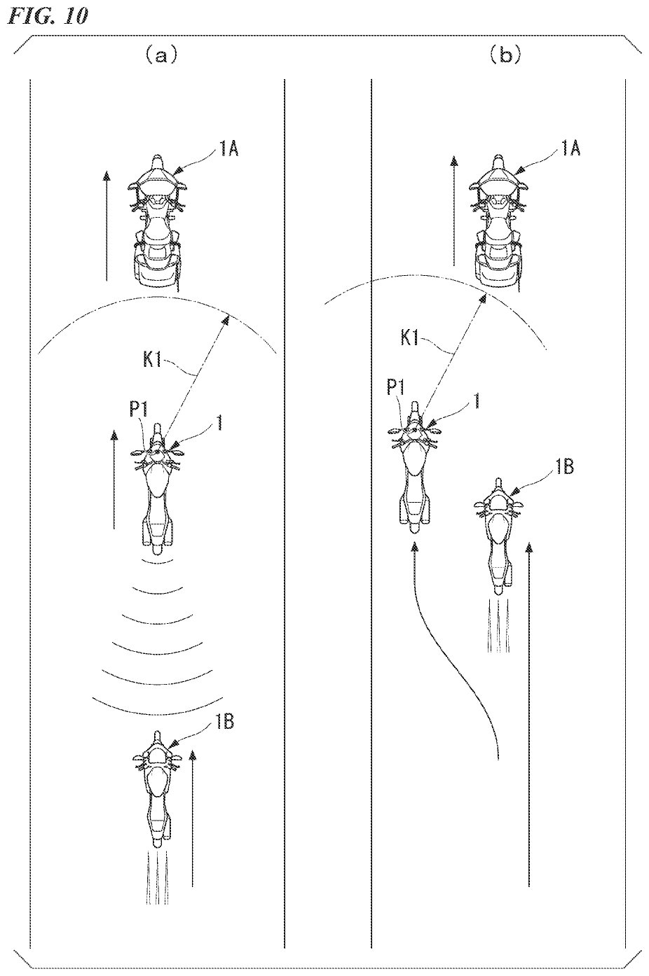

The drive assistance control shown in FIG. 10 is control of urging overtaking the following vehicle 1B. FIG. 10(a) shows the case in which the following vehicle 1B approaches with a prescribed relative speed or more from a side behind the vehicle, for example, when the motorcycle 1 performs normal traveling through drive assistance control of following the preceding vehicle 1A. Here, as shown in FIG. 10(b), the motorcycle 1 changes the traveling trajectory of the host vehicle closer to a road shoulder side (a left side) through intervention control by the control device 23. Accordingly, the following vehicle 1B, which is approaching the motorcycle 1, can overtake the host vehicle without changing the lane.

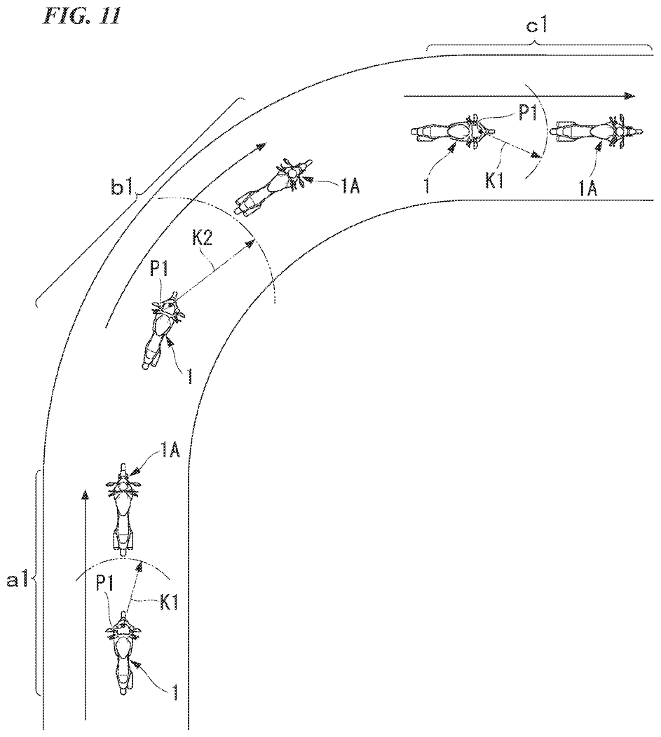

The drive assistance control shown in FIG. 11 shows an example of control of changing a vehicular gap between the preceding vehicle 1A and the motorcycle 1 when the motorcycle 1 follows the preceding vehicle 1A and performs cornering. In this example, the control device 23 controls the following control when the outside detecting sensor SE detects a corner in the direction in which the host vehicle advances. In this control, at least one of the brake device BR and the driving device EN is actuated, and a relative speed with respect to the preceding vehicle 1A is changed. Accordingly, the motorcycle 1 follows the preceding vehicle 1A and performs cornering (in the drawings, a range b1) with a second vehicular gap K2 that is greater than a vehicular gap (a first vehicular gap K1) upon normal traveling (in the drawings, a range a1).

The motorcycle 1 increases a vehicular gap with respect to the preceding vehicle 1A of a follower as the outside detecting sensor SE detects a corner in front of the vehicle. Accordingly, occurrence of acceleration and deceleration during cornering is suppressed. The acceleration and deceleration during turning of the motorcycle 1 (upon vehicle body bank) requires efforts in control of the vehicle body behavior because a vehicle body behavior occurs even in the rolling direction in addition to the pitching direction. On the other hand, tiredness during drive assistance control is reduced by minimizing occurrence of acceleration and deceleration during cornering.

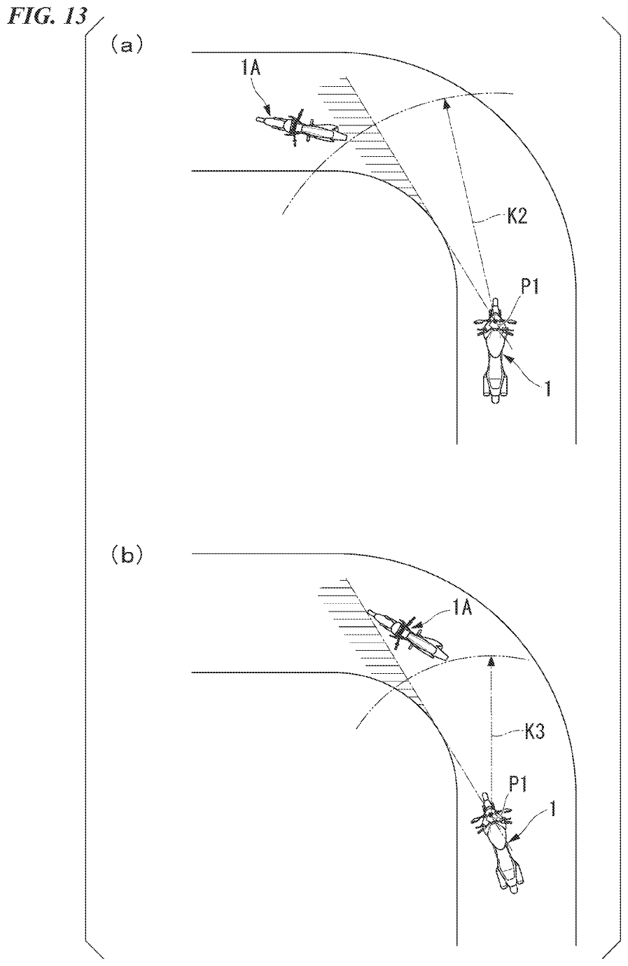

The control device 23 holds the second vehicular gap K2 during cornering in the following travel of the motorcycle 1. However, as shown in FIG. 13, for example, in blind corners where visibility is not good such as a corner on a mountain side (a left side) in a mountain pass, when the vehicular gap is separated, the outside detecting sensor SE may lose sight of the preceding vehicle 1A. The control device 23 actuates at least one of the brake device BR and the driving device EN and performs control of closing a vehicular gap to a distance at which the preceding vehicle 1A can be detected (shown by K3 in the drawings) when the outside detecting sensor SE loses sight of the preceding vehicle 1A during cornering. Accordingly, stable drive assistance control becomes possible without interrupting the following travel during cornering.

Returning to FIG. 11, the control device 23 performs the following control when the outside detecting sensor SE detects a corner exit in the direction in which the host vehicle advances. In this corner, at least one of the brake device BR and the driving device EN is actuated, and a relative speed with respect to the preceding vehicle 1A is changed. Accordingly, the motorcycle 1 shortens the second vehicular gap K2 to return to the first vehicular gap K1 upon normal traveling (in the drawings, a range c1). Accordingly, after cornering, it is possible to quickly return to the following travel state before cornering.

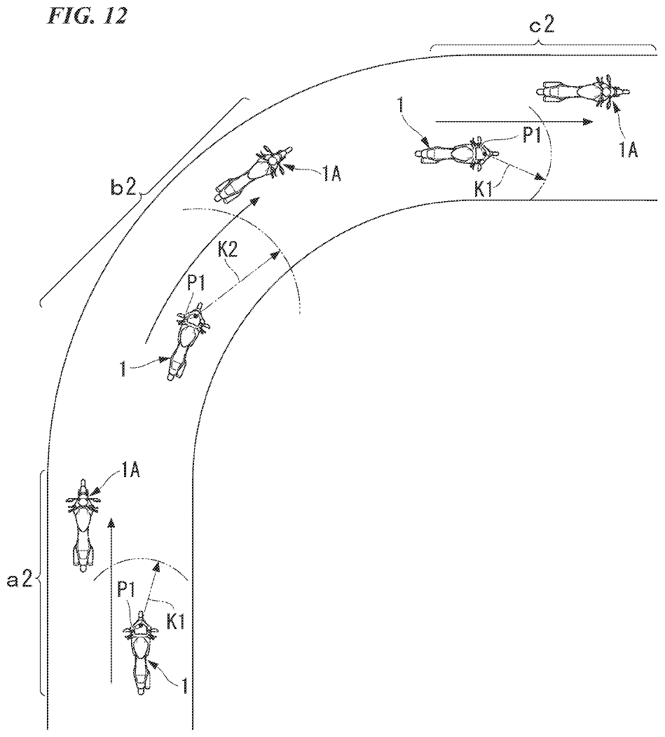

As shown in FIG. 12, the control device 23 performs control of cornering the host vehicle while adjusting the vehicular gap between the preceding vehicle 1A and the host vehicle as described above even when the control mode of performing the zigzag traveling is executed by the plurality of vehicles (in FIG. 12, only two vehicles are shown). Here, measurement of the vehicular gap between the preceding vehicle 1A and the host vehicle is performed in an inclined direction oriented diagonally forward (a direction in which the preceding vehicles 1A arranged in a zigzag manner are directed) with respect to the traveling trajectory that follows a curve of the corner. Accordingly, it is possible to perform cornering while maintaining the vehicular gap in a state in which the plurality of vehicles are zigzag traveling. In the drawings, a range a2 indicates a range of a vehicular gap K1 before cornering, reference sign b2 indicates a range of a vehicular gap K2 during cornering, and reference sign c2 indicates a range of a vehicular gap K3 after cornering.

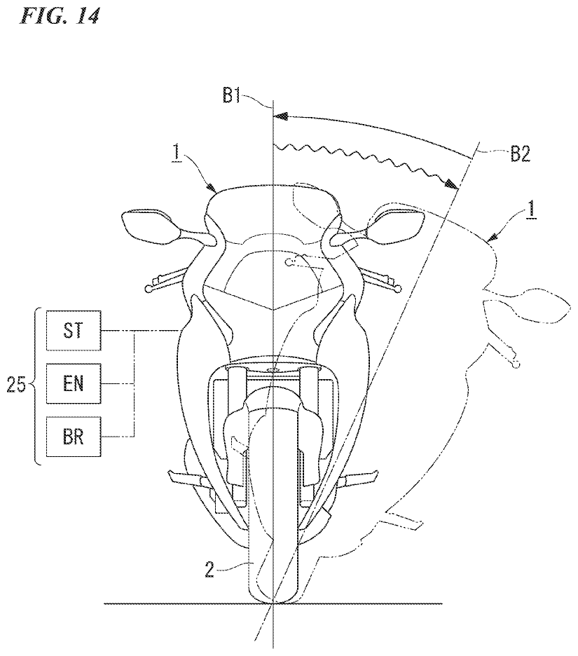

As shown in FIG. 14, the control device 23 performs the following control when the vehicle body behavior generating part 25 is actuated and the vehicle body is banked upon drive assistance of the host vehicle. In this control, when the vehicle body is shifted from an erected state B1 to a bank state B2, an increase speed of the roll angle detected by the vehicle body behavior detecting part 28 is controlled to be less than a predetermined roll speed threshold. Accordingly, the bank of the vehicle body is gentled to improve controllability.

Meanwhile, the control device 23 performs the following control when the vehicle body behavior generating part 25 is actuated to return the vehicle body to the erected state. In this control, when the vehicle body is returned to the erected state B1 from the bank state B2, control of increasing the vehicle speed is performed while erecting the vehicle body without restricting the increase speed of the roll angle detected by the vehicle body behavior detecting part 28. Accordingly, effort of the rider J is reduced by immediately bringing the vehicle body closer to the erected state.

The control device 23 intervenes a steering assistance force using an actuation of the steering device ST upon deceleration during cornering in which the vehicle body is banked during drive assistance of the host vehicle. Accordingly, it causes the vehicle body to rise from the bank state, brings the vehicle body closer to the erected state, and reduces the effort of the rider J.

Further, the control device 23 may intervenes the driving force using an actuation of the driving device EN during cornering in which the vehicle body is banked upon drive assistance of the host vehicle. Here, a turning force is increased by a so-called rear steering, and simultaneously, corner escape becomes smooth. In addition, it causes the vehicle body to rise from the bank state, brings the vehicle body closer to the erected state, and reduces tiredness of the rider J.

In the cornering of the motorcycle 1, a driving force of the engine is lowered upon entering the corner, and the driving force of the engine 10 is used to stabilize the turning movement during turning. Meanwhile, in the following travel to the preceding vehicle 1A, when the host vehicle is turned at a fixed vehicle speed, the rider J may feel discomfort and may affect attractiveness of products.

Here, maneuverability without discomfort of the rider J is realized and improves attractiveness of products by automatically controlling the driving force of the engine 10 as described above within a range in which there is no influence on the vehicle speed.

While the drive assistance control enables the cornering of the motorcycle 1 without the operation by the rider J, it is possible to prioritize the operation intention of the rider J and intervene the operation by the rider J during control.

Here, the motorcycle 1 generates a steering assistance force around the steering shaft 4c through driving of the steering actuator 43. Strength of the assistance force is set such that the steering operation of the rider J is not interfered.

For example, when the motorcycle 1 travels in the erected state, if a clockwise steering assistance force is generated at the center of the steering shaft 4c, the following effects occur. That is, in the motorcycle 1, an action (a roll assistance force) that attempts to roll the vehicle body to the left (a side opposite to the steering direction) occurs. In other words, counter steering causes an action so as to bank the vehicle body.

After that, the counter steering disappears along as an increase in bank angle, and further, the front wheel 2 becomes a self steering state with a steering angle toward the bank. Then, when the bank angle and the steering angle reach a predetermined angle according to the vehicle speed or the like, turning traveling that keeps the bank angle and the steering angle is started.

For example, when the motorcycle 1 is turning with the vehicle body rolled (banked) to the left, if a counterclockwise steering assistance force is generated at the center of the steering shaft 4c (on the same side as the roll direction), the following effects occur. That is, in the motorcycle 1, the action of raising the vehicle body to the right (a side opposite to the steering direction) occurs. In other words, an action of returning the vehicle body to the erected state is generated by increasing a turning amount of the handle of the steering mechanism 4S.

The controller 27 controls driving of the steering actuator 43 such that an increase speed (an increasing rate) of the bank angle (the roll angle) is less than a predetermined threshold when the motorcycle 1 is banked (when the bank angle is increased). The motorcycle 1 will tilt-down more slowly and it will be easier to control the vehicle body by restricting the increase speed in bank angle.

The controller 27 does not restrict the decrease speed of the bank angle when raising the motorcycle 1 from the bank state (when reducing the bank angle), and makes it easier to return vehicle body to the erected state. Accordingly, the behavior of the vehicle body is suppressed with respect to the bank state of the vehicle body, and it is possible to quickly shift to the acceleration at the end of the cornering.

The acceleration and deceleration during cornering causes not only a behavior in the pitch direction but also a behavior in the roll direction due to adjustment of the vehicle body bank angle. For this reason, the effort of the rider J required for the vehicle body control is larger than that upon straight traveling. On the other hand, reduction in tiredness of the rider J is achieved by assisting adjustment of the acceleration and deceleration and the bank angle during cornering using the control device 23.

As described above, the drive assistance device 24 for a saddle riding-type vehicle according to the embodiment includes the outside detecting part 29 configured to detect a situation around the vehicle, the steering device ST configured to steer the host vehicle, and the controller 27 configured to control driving of the steering device ST, and the controller 27 actuates the steering device ST regardless of the operation of the rider J and moves the traveling trajectory in the lane width direction within the lane along which the host vehicle travels according to the situation around the vehicle detected by the outside detecting part 29.

According to the configuration, in a case the drive assistance control such as following travel control or lane keeping assistance are performed, a position of the host vehicle in the lane width direction inside the same traveling lane can be changed according to the situation around the vehicle detected by the outside detecting part 29. For this reason, in the drive assistance control, for example, it is possible to change the traveling trajectory to the inner side and the outer side inside the same lane during cornering or to arrange the traveling trajectories to be alternately deviated in a zigzag manner in the lane width direction during group traveling, and to enhance marketability of the drive assistance device 24.

In the drive assistance device 24 for a saddle riding-type vehicle, the controller 27 actuates the steering device ST and moves the traveling trajectory toward an outer side of the corner inside the lane while the host vehicle travels when the outside detecting part 29 detects the corner in the direction in which the host vehicle advances.

According to the configuration, it is possible to change the traveling trajectory of the host vehicle to the outside of the corner in the same traveling lane according to the corner in front of the vehicle detected by the outside detecting part 29. Accordingly, it is possible to assist the host vehicle to be disposed on the outer side upon entering the corner, improve visibility of the corner to reduce tiredness of the driver, and produce cornering using the lane width.

In the drive assistance device 24 for a saddle riding-type vehicle, the controller 27 actuates the steering device ST and moves the traveling trajectory toward a center in the lane width direction inside the lane along which the host vehicle is traveling when the outside detecting part 29 detects entry of the host vehicle into the corner.

According to this configuration, during the cornering of the host vehicle, it is possible to move the traveling trajectory from the outside of the corner toward the center in the lane width. Accordingly, after the host vehicle enters the corner from the outer side, it is possible to produce the cornering using the lane width by moving the traveling trajectory to the inner side of the corner (the center side).

In the drive assistance device 24 for a saddle riding-type vehicle, the controller 27 actuates the steering device ST and moves the traveling trajectory to the outer side of the corner inside the lane along which the host vehicle is traveling when the outside detecting part 29 detects the corner exit in the direction in which the host vehicle advances.

According to this configuration, when the host vehicle reaches the corner exit, it is possible to move the traveling trajectory to the outside of the corner from the center side in the lane width. For this reason, it is possible to produce the cornering in which the host vehicle accelerates at the corner exit and bulge out to the outer side.

In the drive assistance device 24 for a saddle riding-type vehicle, the controller 27 actuates the steering device ST and moves the traveling trajectory toward the road shoulder inside the lane along which the host vehicle is traveling when the outside detecting part 29 detects approach of the following vehicle 1B from a side behind the vehicle.

According to this configuration, when approach of the following vehicle 1B is detected, the host vehicle is easily overtaken by the following vehicle 1B that approaches by moving the host vehicle toward the road shoulder inside the traveling lane. Accordingly, marketability of the drive assistance device 24 can be enhanced.

In the drive assistance device 24 for a saddle riding-type vehicle, the controller 27 has a control mode in which the traveling trajectory is shifted with respect to the preceding vehicle 1A in the lane width direction inside the lane along which the host vehicle is traveling when the following travel is performed while maintaining a vehicular gap with respect to the preceding vehicle 1A.

According to this configuration, when following travel with respect to the preceding vehicle 1A, it is possible not only to perform the following travel right after the preceding vehicle 1A but also to perform the following travel to the preceding vehicle 1A by being shifted in the lane width direction. For this reason, for example, when group traveling is performed by a plurality of vehicles, it is possible to assist a so-called zigzag traveling, which is arranged alternately in the lane width direction, and enhance marketability of the drive assistance device 24.

In addition, the drive assistance device 24 for a saddle riding-type vehicle includes the outside detecting part 29 configured to detect a situation around the vehicle, the brake device BR configured to brake the host vehicle, the driving device EN configured to drive the host vehicle, and the controller 27 configured to control operation of the brake device BR and the driving device EN, and the controller 27 actuates at least one of the brake device BR and the driving device EN, performs the following travel control of traveling to follow the preceding vehicle 1A while holding the first vehicular gap K1, adjusts actuation of at least one of the brake device BR and the driving device EN when the following travel control is performed and when the outside detecting part 29 detects the corner in the direction in which the host vehicle advances, and performs control of setting a vehicular gap with respect to the preceding vehicle 1A as the second vehicular gap K2 that is greater than the first vehicular gap K1.

According to this configuration, upon the following travel control, the vehicular gap with respect to the preceding vehicle 1A is increased as the outside detecting part 29 detects the corner in front of the vehicle. Accordingly, occurrence of the acceleration and deceleration during cornering can be minimized Since the acceleration and deceleration during cornering of the saddle riding-type vehicle (upon vehicle body bank) generate not only the vehicle body behavior in the pitching direction but also the vehicle body behavior in the rolling direction, efforts are required in control of the vehicle body behavior. Accordingly, tiredness of the rider J can be reduced by minimizing occurrence of the acceleration and deceleration during cornering.

In the drive assistance device 24 for a saddle riding-type vehicle, the controller 27 performs control of maintaining the second vehicular gap K2 during the cornering in the following travel control.

According to this configuration, a state in which the vehicular gap with respect to the preceding vehicle 1A is increased is maintained during the cornering in the following travel control. Accordingly, it is possible to reduce the tiredness of the rider J by giving a margin to the acceleration and deceleration during cornering.

In the drive assistance device 24 for a saddle riding-type vehicle, the controller 27 adjusts actuation of at least one of the brake device BR and the driving device EN and performs control of closing the vehicular gap until the preceding vehicle 1A is detected when the outside detecting part 29 loses sight of the preceding vehicle 1A during cornering in the following travel control.

According to this configuration, during the following travel control, in the cornering of a blind corner or the like with poor visibility, when the preceding vehicle 1A is lost by increasing the vehicular gap with respect to the preceding vehicle 1A, control of closing the vehicular gap until the preceding vehicle 1A is detected is performed. Accordingly, the stable drive assistance control can be performed without interrupting the following travel during cornering.

In the drive assistance device 24 for a saddle riding-type vehicle, in a case the outside detecting part 29 detects the corner exit in the direction in which the host vehicle advances during the cornering in the following travel control, the controller 27 adjusts actuation of at least one of the brake device BR and the driving device EN and performs control of returning the vehicular gap with respect to the preceding vehicle 1A to the first vehicular gap K1.

According to this configuration, since the vehicular gap with respect to the preceding vehicle 1A is returned to the first vehicular gap K1 before the cornering at the corner exit during the following travel control, after completion of the cornering, it is possible to quickly return to the following travel state before cornering.

In the drive assistance device 24 for a saddle riding-type vehicle, the controller 27 has a control mode of shifting the traveling trajectory in the lane width direction with respect to the preceding vehicle 1A inside the lane along which the host vehicle is traveling during the following travel control, and performs control of adjusting the vehicular gap between the preceding vehicle 1A and the host vehicle shifted in the lane width direction when the cornering is performed in the control mode.

According to this configuration, for example, when the group traveling is performed by a plurality of vehicles, it is possible to assist so-called zigzag traveling in which the vehicles are deviated alternately in the lane width direction, and perform the cornering while maintaining the zigzag traveling. For this reason, marketability of the drive assistance device 24 can be enhanced.

In addition, the drive assistance device 24 for a saddle riding-type vehicle includes the vehicle body behavior generating part 25 configured to generate a behavior including roll movement in the vehicle body by a prescribed output, the controller 27 configured to control driving of the vehicle body behavior generating part 25, and the vehicle body behavior detecting part 28 configured to detect a behavior of the vehicle body, the controller 27 controls the host vehicle such that the increase speed of the bank angle detected by the vehicle body behavior detecting part 28 is less than a predetermined roll speed threshold when the vehicle body behavior generating part 25 is actuated and the vehicle body is banked upon drive assistance of the host vehicle, and the controller 27 raises the vehicle body without any restriction on a decrease speed of the bank angle detected by the vehicle body behavior detecting part 28 when the vehicle body behavior generating part 25 is actuated and the vehicle body rises from the bank state upon drive assistance of the host vehicle.

According to this configuration, when the vehicle body is banked upon drive assistance of the host vehicle, the bank of the vehicle body can be made gentle and controllability can be improved by setting an upper limit on the increase speed of the bank angle. Meanwhile, when the vehicle body rises from the bank state, the effort of the rider J can be reduced by quickly bringing the vehicle body closer to the erected state by raising the vehicle body without restricting the decrease speed of the bank angle.

In the drive assistance device 24 for a saddle riding-type vehicle, the steering device ST configured to steer the host vehicle is provided, and the controller 27 actuates the steering device ST and raises the vehicle body from the bank state upon deceleration during the cornering in which the vehicle body is banked in drive assistance of the host vehicle.

According to this configuration, since the steering device ST is actuated to bring the vehicle body closer to the erected state upon deceleration during cornering of the host vehicle, tiredness of the rider J can be reduced. Conventionally, since the acceleration and deceleration during the vehicle body bank is likely to generate the vehicle body behavior in the roll direction in addition to the pitch direction, an effect of automatically controlling the acceleration and deceleration is enhanced.

In the drive assistance device 24 for a saddle riding-type vehicle, the driving device EN configured to drive the host vehicle is provided, and the controller 27 actuates the driving device EN and the vehicle body rises from the bank state during cornering in which the vehicle body is banked in drive assistance of the host vehicle.

According to this configuration, so-called rear steering is intervened by actuating the driving device EN and generating the driving force during cornering of the host vehicle. For this reason, it is possible to reduce the bank angle of the vehicle body and increase a turning property, and it is possible to reduce the tiredness of the rider J.

Further, the present invention is not limited to the embodiment, and for example, all vehicles on which a driver rides on the vehicle body are included as the saddle riding vehicle, and in addition to a motorcycle (including a motorized bicycle and a scooter-type vehicle), a three-wheeled vehicle (including a two-front-wheeled and one-rear-wheeled vehicle in addition to one-front-wheeled and two-rear-wheeled vehicle) or a four-wheeled vehicle may also be included.

Then, the configuration according to the embodiment is an example of the present invention, and various changes may be made without departing from the scope of the present invention, such as substitution of the components of the embodiment with known components, and the like.

### REFERENCE SIGNS LIST

1 Motorcycle (saddle riding-type vehicle)
1A Preceding vehicle
1B Following vehicle
10 Engine
23 Control device
24 Drive assistance device
25 Vehicle body behavior generating part
27 Controller
28 Occupant behavior detecting part
29 External detecting part
38 Outside detecting camera
BR Brake device
EN Driving device
ST Steering device
SE Outside detecting sensor
J Rider
K1, K2 Vehicular gap

What is claim is:

1. A drive assistance device for a saddle riding-type vehicle comprising:
an outside detecting part configured to detect a situation around the vehicle;
a brake device configured to brake a host vehicle;
a driving device configured to drive the host vehicle; and
a controller configured to control operation of the brake device and the driving device,
wherein the controller performs following travel control that causes the host vehicle to travel with a first vehicular gap while following a preceding vehicle by actuating at least one of the brake device and the driving device, adjusts actuation of at least one of the brake device and the driving device when the outside detecting part detects a corner in a direction in which the host vehicle advances while the following travel control is performed, and performs control of setting a vehicular gap with respect to the preceding vehicle as a second vehicular gap that is greater than the first vehicular gap.

2. The drive assistance device for a saddle riding-type vehicle according to claim 1, wherein the controller performs control of maintaining the second vehicular gap during cornering in the following travel control.

3. The drive assistance device for a saddle riding-type vehicle according to claim 2, wherein, in a case the outside detecting part loses sight of a preceding vehicle during cornering in the following travel control, the controller adjusts actuation of at least one of the brake device and the driving device and performs control of closing a vehicular gap until a preceding vehicle is detected.

4. The drive assistance device for a saddle riding-type vehicle according to claim 2, wherein, in a case the outside detecting part detects a corner exit in the direction in which the host vehicle advances during cornering in the following travel control, the controller adjusts actuation of at least one of the brake device and the driving device and performs control of returning a vehicular gap with respect to the preceding vehicle to the first vehicular gap.

5. The drive assistance device for a saddle riding-type vehicle according to claim 1, wherein, during the following travel control, the controller has a control mode of shifting a traveling trajectory of the host vehicle in a lane width direction with respect to a preceding vehicle inside a lane along which the host vehicle is traveling, and performs control of adjusting a vehicular gap between the preceding vehicle and the host vehicle shifted in the lane width direction when cornering is performed in the control mode.
